(19) United States
(12) Patent Application Publication
(10) Pub. No.: US 2007/0066293 A1
(43) Pub. Date: Mar. 22, 2007

(54) MOBILE COMMUNICATION DEVICE, METHOD FOR DOWNLOADING CONFIGURATION FILES, AND WIRELESS COMMUNICATION SYSTEM

(75) Inventors: Chen Peng, TU CHENG (TW); Shu-Ken Lin, TU CHENG (TW); Chia-Chi Lin, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,747

(22) Filed: Apr. 28, 2006

(30) Foreign Application Priority Data
Sep. 16, 2005 (TW) 94132092

(51) Int. Cl. H04M 3/00

(52) U.S. Cl. 455/418

(57) ABSTRACT

A mobile communication device (10) includes a Man-Machine Interface (MMI) module (310), a network connection detecting module (340), a message module (330), an automatic setting activating module (320), and a provision module (350). The MMI module saves preset network setting data and network setting modes. The message module is connected to the MMI module for transmitting messages. The network connection detecting module is connected to the message module for detecting network signals, generating network connection status messages, and sending the network connection status massages to the message module. The automatic setting activating module is connected to the message module for automatically establishing a network setting of the mobile communication device. The provision module is connected to the message module, the automatic setting activating module, and the network connection detecting module for downloading and combining configuration files of different priority levels after the network setting is established.

### FIELD OF THE INVENTION

The invention relates to mobile communication devices, and particularly to a mobile communication device, a method for downloading configuration files, and a wireless communication system utilizing the mobile communication device and the method.

### DESCRIPTION OF RELATED ART

Mobile communication devices, for example, mobile phones, have become popular due to their mobility and portable convenience. However, configuration files of different mobile communication devices may be different. If service providers need to modify common settings of mobile communication devices, the service providers need to modify all configuration files. It is inefficient and inconvenient.

In addition, the service providers usually solve the above problem by sending the configuration files to users of the mobile communication devices via short messages, then the users have to manually set up new configuration files. However, it is problematic for most users to correctly install the configuration files.

### SUMMARY OF THE INVENTION

An exemplary embodiment of the invention provides a mobile communication device. The mobile communication device includes a Man-Machine Interface (MMI) module, a network connection detecting module, a message module, an automatic setting activating module, and a provision module. The MMI module stores preset network setting data and network setting modes. The message module is connected to the MMI module for transmitting messages. The network connection detecting module is connected to the message module for detecting network signals, generating network connection status messages, and sending the network connection status massages to the message module. The automatic setting activating module is connected to the message module for automatically establishing a network setting of the mobile communication device. The provision module is connected to the message module, the automatic setting activating module, and the network connection detecting module for downloading and combining configuration files of different priority levels after the network setting of the mobile communication device is established.

Another exemplary embodiment of the invention provides a wireless communication system. The wireless communication system includes a configuration server, a network setting server, and a mobile communication device. The configuration server stores configuration files of different priority levels. The network setting server is used for automatically establishing a network setting of the mobile communication device. The mobile communication device is wirelessly connected to the configuration server and the network setting server via a network, and includes a Man-Machine Interface (MMI) module, a network connection detecting module, a message module, an automatic setting activating module, and a provision module. The MMI module stores preset network setting data and network setting modes. The message module is connected to the MMI module for transmitting messages. The network connection detecting module is connected to the message module for detecting network signals, generating network connection status messages, and sending the network connection status massages to the message module. The automatic setting activating module is connected to the message module for automatically establishing a network setting of the mobile communication device. The provision module is connected to the message module, the automatic setting activating module, and the network connection detecting module for downloading and combining the configuration files after the network setting of the mobile communication device is established.

A further exemplary embodiment of the invention provides a method for downloading configuration files. The method utilized in a mobile communication device includes steps of: generating a network connection status message, and transmitting the network connection status message via a message module; establishing a network setting of the mobile communication device after receiving a network connection complete message; downloading configuration files of different priority levels after the network setting is established; and combining the configuration files after downloading is complete.

Other advantages and novel features will become more apparent from the following detailed description when taken in conjunction with the accompanying drawings, in which:

### BRIEF DESCRIPTION OF THE DRAWINGS

FIG. 1 is a schematic diagram of a wireless communication system of an exemplary embodiment of the invention;

FIG. 2 is a block diagram of a mobile communication device of another exemplary embodiment of the invention;

FIG. 3 is a flowchart of a method for downloading configuration files of a further exemplary embodiment of the invention;

FIG. 4 is a flowchart of a step of generating a network connection status message, and transmitting the network connection status message by a message module of a further exemplary embodiment of the invention;

FIG. 5 is a flowchart of a step of establishing a network setting of the mobile communication device of a further exemplary embodiment of the invention;

FIG. 6 is a flowchart of a step of downloading configuration files of different priority levels of a further exemplary embodiment of the invention;

FIG. 7 is a flowchart of a step of downloading configuration files of different priority levels from a configuration server of a further exemplary embodiment of the invention; and

FIG. 8 is a flowchart of a step of downloading configuration files of different priority levels from a backup configuration server of a further exemplary embodiment of the invention.

### DETAILED DESCRIPTION OF THE INVENTION

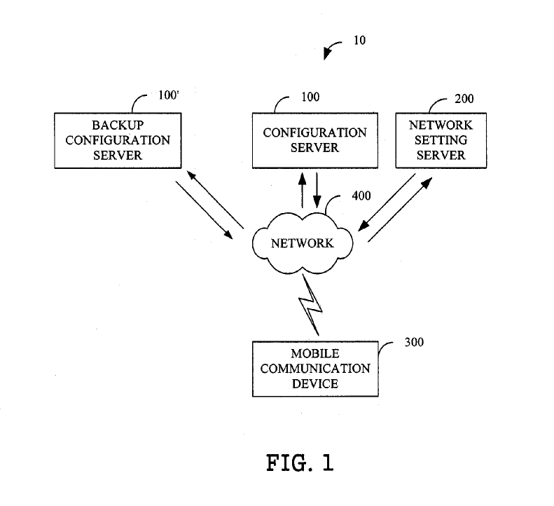

FIG. 1 is a schematic diagram of a wireless communication system 10 of an exemplary embodiment of the invention. In the exemplary embodiment, the wireless communication system 10 includes a configuration server 100, a network setting server 200, a mobile communication device 300, and a network 400. In the exemplary embodiment, the network 400 may be a wireless network. The configuration server 100 stores configuration files. In the exemplary embodiment, the configuration files have different priority levels. For example, the configuration files may be of three types, such as specific configuration files, group configuration files, and common configuration files. Each of the specific configuration files is only for a specific mobile communication device using the network 400, the group configuration files are for a group of mobile communication devices using the network 400, and the common configuration files are for all mobile communication devices using the network 400. A priority level of the specific configuration files is the highest, a priority level of the group configuration files is lower, and a priority level of the common configuration files is the lowest.

The network setting server 200 can automatically establish a network setting of the mobile communication device 300. In the exemplary embodiment, the network setting server 200 includes a dynamic host configuration protocol (DHCP) server. The mobile communication device 300 is wirelessly connected to the configuration server 100 and the network setting server 200 via the network 400. In the exemplary embodiment, the mobile communication device 300 includes a dual mode mobile phone, and the network 400 includes a WIFI network and a global system for mobile communication (GSM) network.

In the exemplary embodiment, the wireless communication system 10 further includes a backup configuration server 100′. The backup configuration server 100′ is connected to the configuration server 100 via the network 400 and wirelessly connected to the mobile communication device 300 via the network 400, and stores the same configuration files as the configuration server 100. In alternative embodiments, the backup configuration server 100′ is directly connected to the configuration server 100.

The configuration server 100, the network setting server 200, and the backup configuration server 100′ can be located in a location of a service provider. If the service provider needs to modify the configuration files of one or more mobile communication devices 300, the service provider need only to modify the configuration files of the one or more mobile communication devices 300 in the configuration server 100 or in the backup configuration server 100′. Then, the one or more mobile communication devices 300 will automatically download the modified configuration files from the configuration server 100 or the backup configuration server 100′.

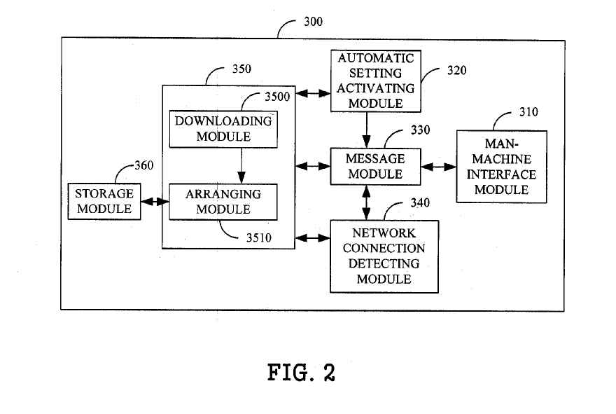

FIG. 2 is a block diagram of the mobile communication device 300 of an exemplary embodiment of the invention. In the exemplary embodiment, the mobile communication device 300 includes a man-machine interface (MMI) module 310, an automatic setting activating module 320, a message module 330, a network connection detecting module 340, a provision module 350, and a storage module 360. The MMI module 310 stores preset network setting data and network setting modes preset by manufacturers. In the exemplary embodiment, the network setting modes include a manual setting mode and an automatic setting mode. The preset network setting data is used for manually establishing a network setting of the mobile communication device 300, if the network setting mode of the mobile communication device 300 is in the manual setting mode. The automatic setting activating module 320 is connected to the message module 330 for automatically establishing a network setting of the mobile communication device 300, if the network setting mode of the mobile communication device 300 is in the automatic setting mode. In the exemplary embodiment, the automatic setting activating module 320 includes a DHCP client. If the network setting mode of the mobile communication device 300 is in the automatic setting mode, the automatic setting activating module 320 communicates with the network setting server 200, thereby activating the network setting server 200 to automatically establish the network setting of the mobile communication device 300. The message module 330 is connected to the MMI module 310 and the automatic setting activating module 320 for transmitting messages. In the exemplary embodiment, the message module 330 transmits messages to all modules of the mobile communication device 300.

The network connection detecting module 340 is connected to the message module 330 for detecting network signals, generating network connection status messages, and sending the network connection status messages to the message module 330. In the exemplary embodiment, the network connection status messages include a network connection complete message and a network connection lost message. In the exemplary embodiment, if the network connection detecting module 340 detects network signals from the network 400, the network connection detecting module 340 generates the network connection complete message, and sends the network connection complete message to the message module 330. Then the message module 330 sends the network connection complete message to all modules of the mobile communication device 300. If the network connection detecting module 340 does not detect network signals from the network 400, the network connection detecting module 340 generates the network connection lost message, and sends the network connection lost message to the message module 330. Then the message module 330 sends the network connection lost message to all modules of the mobile communication device 300.

The provision module 350 determines the network setting mode, thereby a corresponding network setting of the mobile communication device 30 can be established. The provision module 350 is connected to the automatic setting activating module 320, the message module 330, and the network connection detecting module 340 for automatically downloading and combining the configuration files from the configuration server 100 or from the backup configuration server 100′, after the network setting of the mobile communication device 300 is established. In the exemplary embodiment, the network setting server 200 automatically establishes the network setting of the mobile communication device 30, or a user manually establishes the network setting of the mobile communication device 30 according to the preset network setting data. In the exemplary embodiment, the provision module 350 includes a downloading module 3500 and an arranging module 3510. The downloading module 3500 automatically downloads the configuration files from the configuration server 100 or the backup configuration server 100′. In the exemplary embodiment, the downloading module 3500 begins by looking for a configuration file of the lowest priority first, and if successful downloads it, then continues on to the next priority level until finishing up with the highest priority. If the downloading module 3500 does not detect a configuration file, and the priority level of the configuration file is not the highest, the downloading module 3500 continues on to download a configuration file of the next priority level; if the priority level of the configuration file is the highest, the downloading module 3500 stops downloading, and deletes any newly downloaded configuration files. That is, no newly downloaded files are kept unless they include the configuration files with the highest priority level. In the exemplary embodiment, the downloading module 3500 initially downloads the common configuration files, then the specific configuration files, and finally the group configuration files. In the exemplary embodiment, the downloading module 3500 includes a trivial file transfer protocol (TFTP) client.

The arranging module 3510 is connected to the downloading module 3500, for combining the downloaded configuration files into a combined configuration file. If the configuration files of different priority levels have the same data therein, the arranging module 3510 uses the data in the configuration file with the highest priority level. If the downloading module 3500 does not detect a configuration file with the highest priority level, and the downloading module 3500 has stopped downloading, then the arranging module 3510 does not perform the step of combining files.

The storage module 360 is connected to the arranging module 3510 for storing the combined configuration files. In the exemplary embodiment, the storage module 360 includes a file system module. Once the newly downloaded and combined configuration files are stored in the storage module 360, the provision module 350 generates a message to inform the MMI module 310 that the configuration files have been changed.

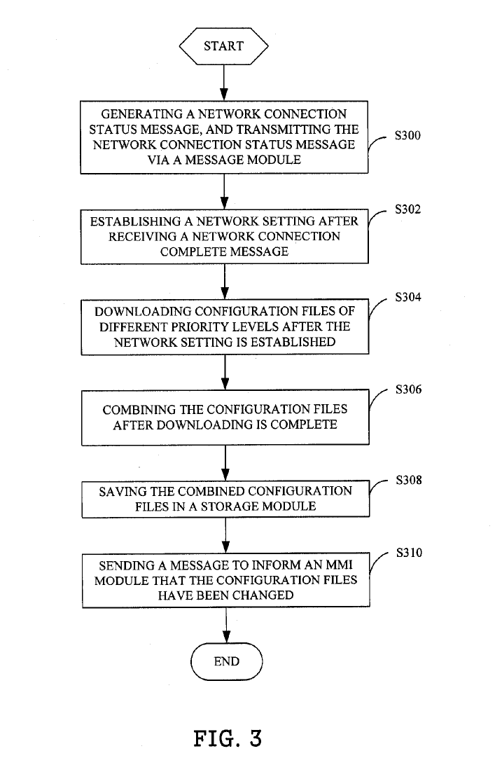

FIG. 3 is a flowchart of a method for downloading configuration files of an exemplary embodiment of the invention. In the exemplary embodiment, the method for downloading configuration files is utilized in the mobile communication device 300, and proceeds automatically without participation of users of the mobile communication device 300, occurring whenever the mobile communication device 300 is powered up or roaming and switching networks or initiated from server side when new configuration files are available. In step S300, the network connection detecting module 340 generates a network connection status message, and transmits the network connection status message via the message module 330. In the exemplary embodiment, the network connection status message includes a network connection complete message and a network connection lost message. In step S302, after the provision module 350 receives the network connection complete message, the network setting of the mobile communication device 300 is established.

In step S304, the downloading module 3500 automatically downloads the configuration files of different priority levels after the network setting of the mobile communication device 300 is established. In the exemplary embodiment, the downloading module 3500 downloads the available configuration files of different priority levels from the configuration server 100 or from the backup configuration server 100′. In step S306, the arranging module 3510 combines the downloaded configuration files after the downloading module 3500 has completed the downloading. In the exemplary embodiment, if the configuration files of different priority levels have the same data therein, the arranging module 3510 uses the data in the configuration file with the highest priority level. In step S308, the arranging module 3510 saves the combined configuration files in the storage module 360 to update old configuration files. If a configuration file whose priority level is not the highest is not downloaded, the configuration files saved in the storage module 360 include the combined configuration files and an old configuration file with the certain priority level. In step S310, the provision module 350 sends a message to inform the MMI module 310 that configuration files of the mobile communication device 300 have been changed via the message module 330.

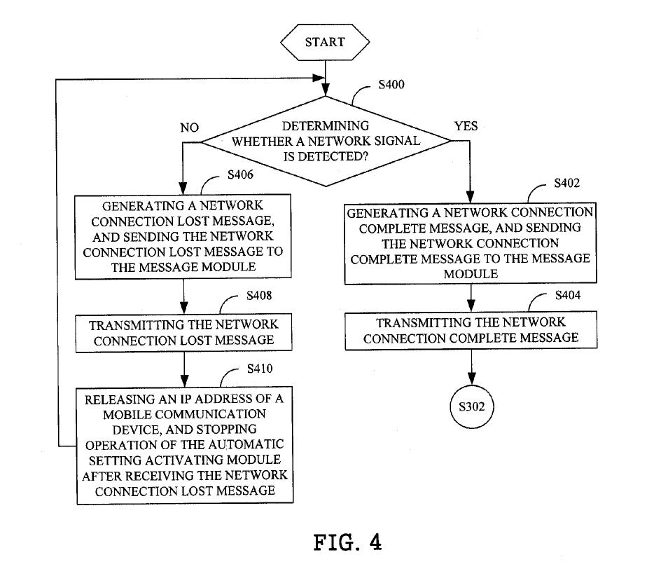

FIG. 4 is a detailed flowchart of step S300. In step S400, the network connection detecting module 340 determines whether a network signal is detected by the network connection detecting module 340, that is, determines whether the mobile communication device 300 can communicate with the network 400. If the network connection detecting module 340 detects the network signal, in step S402, the network connection detecting module 340 generates a network connection complete message, and sends the network connection complete message to the message module 330. In step S404, the message module 330 transmits the network connection complete message to the other modules of the mobile communication device 300. Then the process goes to step S302.

If the network connection detecting module 340 does not detect network signals, in step S406, the network connection detecting module 340 generates a network connection lost message, and sends the network connection lost message to the message module 330. In step S408, the message module 330 transmits the network connection lost message to the other modules. In step S410, after the provision module 350 receives the network connection lost message, the provision module 350 releases an IP address of the mobile communication device 300, and stops the operation of the automatic setting activating module 320. Then the process returns step S400.

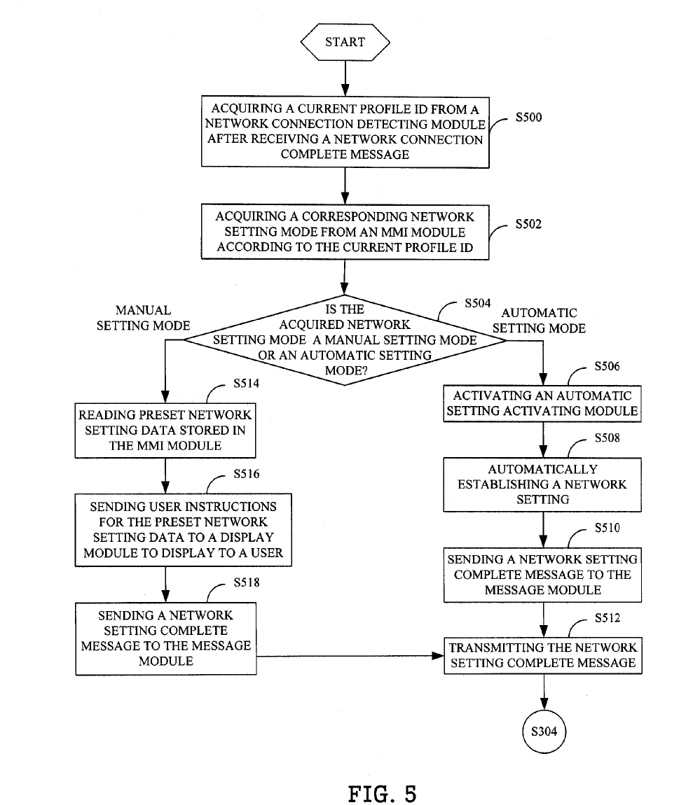

FIG. 5 is a detailed flowchart of step S302 of the above exemplary embodiment of the invention. In step S500, after the provision module 350 receives the network connection complete message, the provision module 350 acquires a current profile identifier (ID) from the network connection detecting module 340. In the exemplary embodiment, the profile ID includes different network IDs, for example, GSM network IDs and WIFI network IDs. In step S502, the provision module 350 acquires a corresponding network setting mode from the MMI module 310 according to the current profile ID. In the exemplary embodiment, the network setting mode includes the manual setting mode represented by “0” and the automatic setting mode represented by “11”. In alternative embodiments, the manual setting mode can be represented by “1,” and the automatic setting mode can be represented by “0,” as long as different setting modes are assigned with different digits. In the exemplary embodiment, if the current profile ID is the GSM network ID, the network setting mode of the mobile communication device 300 is the automatic setting mode; if the current profile ID is the WIFI network ID, the network setting mode of the mobile communication device 300 is the manual setting mode. In step S504, the provision module 350 determines whether the acquired network setting mode is the manual setting mode or the automatic setting mode.

If the acquired network setting mode is the automatic setting mode, in step S506, the provision module 350 activates the automatic setting activating module 320. In step S508, the automatic setting activating module 320 communicates with the network setting server 200, then the network setting server 200 automatically establishes the network setting of the mobile communication device 300. In the exemplary embodiment, the network setting server 200 establishes the network setting via a dynamic host configuration setting. In step S510, the automatic setting activating module 320 sends a network setting complete message to the message module 330 after the network setting of the mobile communication device 300 is established. In the exemplary embodiment, the network setting complete message includes network setting data of the mobile communication device 300, for example, IP addresses of the configuration server 100 and the backup configuration server 100′. In step S512, the message module 330 transmits the network setting complete message to the other modules. Then the process goes to step S304.

If the acquired network setting mode is the manual setting mode, in step S514, the provision module 350 reads the preset network setting data stored in the MMI module 310 for a manual network setting of the mobile communication device 300. In step S516, the provision module 350 sends user instructions for the preset network setting data to a display module (not shown) to display to the user of the mobile communication device 300. Thus, the user establishes the manual network setting of the mobile communication device 300 according to the instructions displayed. In step S518, the provision module 350 sends a network setting complete message to the message module 330 after the manual network setting is established. Then the process turns to the step S512.

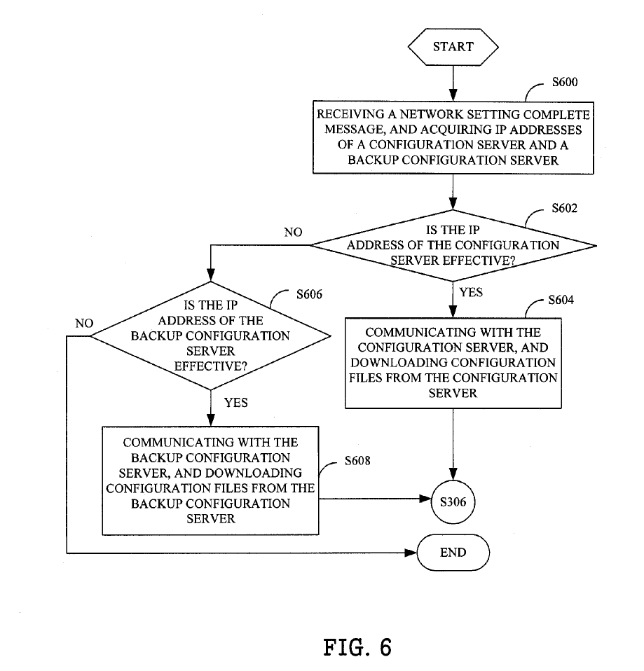

FIG. 6 is a detailed flowchart of step S304 of an exemplary embodiment of the invention. In step S600, the provision module 350 receives the network setting complete message transmitted by the message module 330, and acquires IP addresses of the configuration server 100 and the backup configuration server 100′ from the network setting complete message. In step S602, the provision module 350 determines whether the IP address of the configuration server 100 is effective. If the IP address of the configuration server 100 is effective, in step S604, the mobile communication device 300 communicates with the configuration server 100, and the downloading module 3500 downloads the configuration files of different priority levels from the configuration server 100. Then the process goes to step S306.

If the IP address of the configuration server 100 is not effective, in step S606, the provision module 350 determines whether the IP address of the backup configuration server 100′ is effective. If the IP address of the backup configuration server 100′ is effective, in step S608, the mobile communication device 300 communicates with the backup configuration server 100′, and the download module 3500 downloads the configuration files of different priority levels from the backup configuration server 100′. Then the process goes to step S306. If the IP address of the backup configuration server 100′ is not effective, the downloading module 3500 stops, and the process ends.

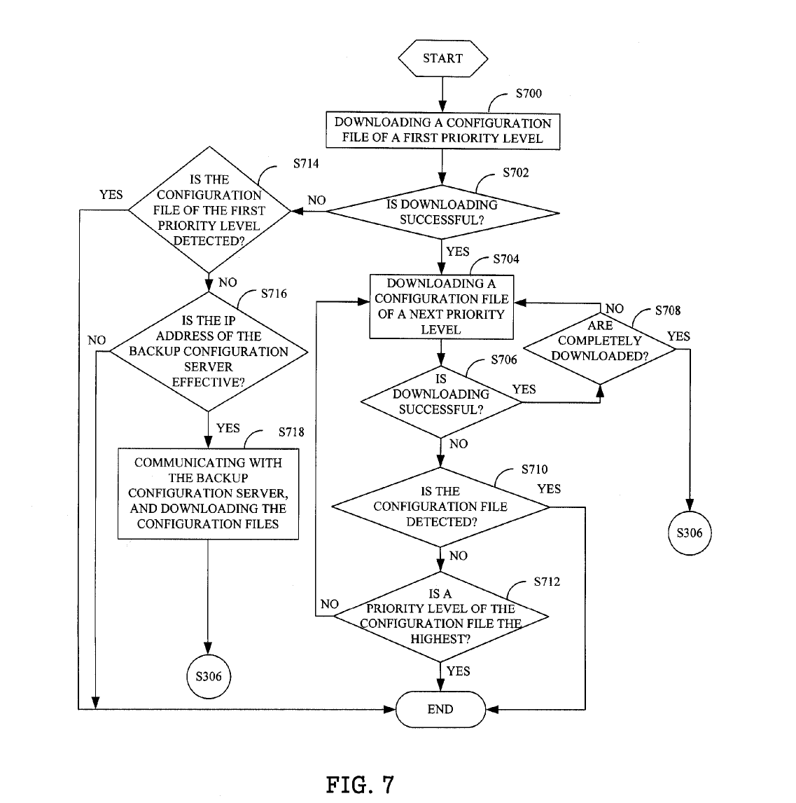

FIG. 7 is a detailed flowchart of step S604 of an exemplary embodiment of the invention. In step S700, the downloading module 3500 downloads a configuration file of a first priority level from the configuration server 100. In step S702, the downloading module 3500 determines whether downloading of the configuration file of the first priority level is successful.

If the downloading is unsuccessful, in step S714, the downloading module 3500 determines whether the configuration file of the first priority level is detected in the configuration server 100 by the downloading module 3500. If the configuration file of the first priority level is detected, the downloading module 3500 stops, and the process ends. If the configuration file of the first priority level is not detected, in step S716, the provision module 350 determines whether the IP address of the backup configuration server 100′ is effective. If the IP address of the backup configuration server 100′ is not effective, the downloading module 3500 stops, and the process ends. If the IP address of the backup configuration server 100′ is effective, in step S718, the mobile communication device 300 communicates with the backup configuration server 100′, and the downloading module 3500 downloads the configuration files of different priority levels from the backup configuration server 100′. Then the process goes to step S306.

If the downloading of the configuration file of the first priority level is successful, in step S704, the downloading module 3500 downloads a configuration file of the next priority level from the configuration server 100. In step S706, the downloading module 3500 determines whether the downloading of the configuration file of the next priority level is successful. If successful, in step S708, the downloading module 3500 determines whether the configuration files of different priority levels are completely downloaded. If the configuration files of different priority levels are completely downloaded, the process goes to step S306. If the configuration files of different priority levels are not completely downloaded, the process returns step S704.

If the downloading of the configuration file of the next priority level is unsuccessful, in step S710, the downloading module 3500 determines whether the configuration file of the next priority level is detected in the configuration server 100 by the downloading module 3500. If the configuration file of the next priority level is detected, the downloading module 3500 stops, and the process ends. If the configuration file of the next priority level is not detected, in step S712, the downloading module 3500 determines whether the priority level of the configuration file of the next priority level is the highest. If the priority level of the configuration file of the next priority level is the highest, the downloading module 3500 stops, and the process ends. If the priority level of the configuration file of the next priority level is not the highest, the process returns step S704.

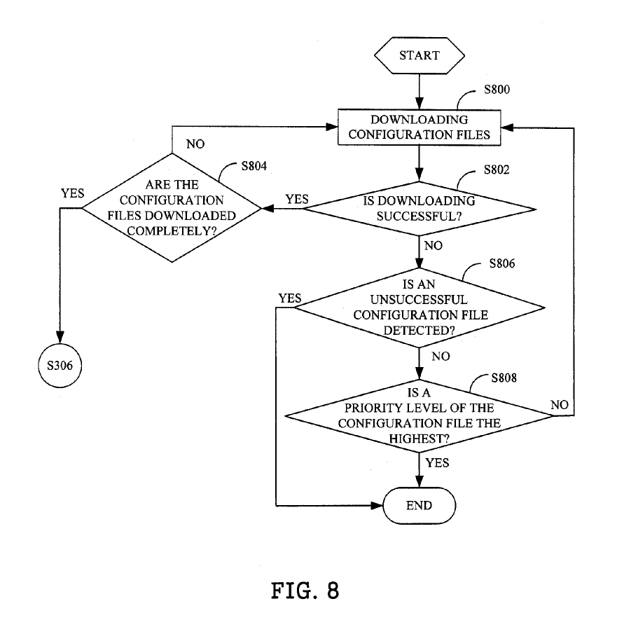

FIG. 8 is a flowchart of the step of downloading configuration files of different priority levels from the backup configuration server 100′ of an exemplary embodiment of the invention, that is, a detailed flow chart of steps S608 and S718. In step S800, the downloading module 3500 downloads the configuration files of different priority levels from the backup configuration server 100′. In step S802, the downloading module 3500 determines whether the downloading of the configuration files is successful. If successful, in step S804, the downloading module 3500 determines whether the configuration files of different priority levels are completely downloaded. If the configuration files of different priority levels are not completely downloaded, the process returns step S800. If the configuration files of different priority levels are completely downloaded, the process goes to step S306.

If the downloading of the configuration files of different priority levels is unsuccessful, in step S806, the downloading module 3500 determines whether an unsuccessful configuration file is detected in the backup configuration server 100′ by the downloading module 3500. If the unsuccessful configuration file is detected, the downloading module 3500 stops, and the process ends. If the unsuccessful configuration file is not detected, in step S808, the downloading module 3500 determines whether a priority level of the unsuccessful configuration file is the highest. If the priority level of the unsuccessful configuration file is not the highest, the process returns step S800. If the priority level of the unsuccessful configuration file is the highest, the downloading module 3500 stops, and the process ends.

The mobile communication device 300 automatically downloads the configuration files of different priority levels without participation of the user of the mobile communication device 300. Thus, it is convenient for the user. In addition, if service providers need to modify configuration files of one mobile communication device 300, the service providers only need to modify the specific configuration files of the mobile communication device 300 without modifying all configuration files.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A mobile communication device, comprising:
a Man-Machine Interface (MMI) module for saving preset network setting data and network setting modes;
a message module, connected to the MMI module, for transmitting messages;
a network connection detecting module, connected to the message module, for detecting network signals, generating network connection status messages, and sending the network connection status massages to the message module;
an automatic setting activating module, connected to the message module, for automatically establishing a network setting of the mobile communication device; and
a provision module, connected to the message module, the automatic setting activating module, and the network connection detecting module, for downloading and combining configuration files of different priority levels after the network setting of the mobile communication device is established.

2. The mobile communication device as claimed in claim 1, wherein the provision module comprises:
a downloading module for respectively downloading the configuration files of different priority levels; and
an arranging module, connected to the downloading module, for combining the downloaded configuration files.

3. The mobile communication device as claimed in claim 1, wherein the network setting mode of the MMI module comprises a manual setting mode and an automatic setting mode, and the provision module further determines the network setting mode.

4. The mobile communication device as claimed in claim 1, wherein the network connection status messages comprise a network connection complete message and a network connection lost message.

5. A wireless communication system, comprising:
a configuration server for saving configuration files of different priority levels;
a network setting server for automatically establishing network settings; and
a mobile communication device, wirelessly connected to the configuration server and the network setting server via a network, comprising:
a Man-Machine Interface (MMI) module for saving preset network setting data and network setting modes;
a message module, connected to the MMI module, for transmitting messages;
a network connection detecting module, connected to the message module, for detecting network signals, generating network connection status messages, and sending the network connection status massages to the message module;
an automatic setting activating module, connected to the message module, for automatically establishing a network setting of the mobile communication device; and
a provision module, connected to the message module, the automatic setting activating module, and the network connection detecting module, for downloading and combining the configuration files of different priority levels after the network setting of the mobile communication device is established.

6. The wireless communication system as claimed in claim 5, further comprising a backup configuration server, connected to the configuration server via the network, for storing the same configuration files of different priority levels as the configuration server.

7. The wireless communication system as claimed in claim 5, wherein the provision module comprises:
a downloading module for downloading the configuration files of different priority levels; and
an arranging module, connected to the downloading module, for combining the downloaded configuration files.

8. The wireless communication system as claimed in claim 5, wherein the network setting modes of the MMI module comprise a manual setting mode and an automatic setting mode, and the provision module further determines the network setting mode.

9. A method for downloading configuration files, utilized in a mobile communication device, comprising:
generating a network connection status message, and transmitting the network connection status message via a message module;
establishing a network setting of the mobile communication device after receiving a network connection complete message;
downloading configuration files of different priority levels after the network setting is established; and
combining the downloaded configuration files of different priority levels after downloading is complete.

10. The method as claimed in claim 9, wherein the step of generating a network connection status message, and transmitting the network connection status message via a message module comprises steps of:
determining whether a network signal is detected;
if detecting a network signal, generating a network connection complete message, and sending the network connection complete message to the message module; and
transmitting the network connection complete message to all modules of the mobile communication device.

11. The method as claimed in claim 10, wherein the step of generating a network connection status message, and transmitting the network connection status message via a message module further comprises steps of:
if no network signal is detected, generating a network connection lost message, and sending the network connection lost message to the message module;
transmitting the network connection lost message to all module of the mobile communication device; and
releasing an IP address of the mobile communication device, and stopping operation of an automatic setting activating module after receiving the network connection lost message.

12. The method as claimed in claim 9, wherein the step of establishing a network setting comprises steps of:
acquiring a current profile identifier (ID) from a network connection detecting module after receiving the network connection complete message;
acquiring a corresponding network setting mode from an man-machine interface (MMI) module according to the current profile ID;
determining whether the acquired network setting mode is a manual setting mode or an automatic setting mode;
if the network setting mode is the manual setting mode, reading preset network setting data stored in the MMI module;
sending a network setting complete message to the message module after a manual network setting of the mobile communication device is established; and
transmitting the network setting complete message to all modules of the mobile communication device.

13. The method as claimed in claim 12, wherein the step of establishing a network setting further comprises steps of:
if the network setting mode is the automatic setting mode, activating an automatic setting activating module;
automatically establishing the network setting of the mobile communication device; and
sending a network setting complete message to the message module after the network setting is established.

14. The method as claimed in claim 9, wherein the step of downloading configuration files of different priority levels comprises steps of:
receiving the network setting complete message, and acquiring IP addresses of a configuration server and a backup configuration server;
determining whether the IP address of the configuration server is effective; and
communicating with the configuration server, and downloading the configuration files of different priority levels from the configuration server if the IP address of the configuration server is effective.

15. The method as claimed in claim 14, wherein the step of downloading the configuration files of different priority levels from the configuration server comprises steps of:
downloading a configuration file of a first priority level;
determining whether the downloading is successful;
downloading a configuration file of the next priority level if the downloading is successful;
determining whether the downloading of the configuration file of the next priority level is successful;
determining whether the configuration files are completely downloaded if the downloading of the configuration file of the next priority level is successful; and
downloading a configuration file of the next priority level if the configuration files are not completely downloaded.

16. The method as claimed in claim 15, wherein the step of downloading the configuration files of different priority levels from the configuration server further comprises steps of:
determining whether the configuration file of the first priority level is detected in the configuration server if the downloading the configuration file of the first priority level is unsuccessful;
determining whether the IP address of the backup configuration server is effective if the configuration file of the first priority level is not detected; and
if the IP address of the backup configuration server is effective, communicating with the backup configuration server, and downloading the configuration files of different priority levels from the backup configuration server.

17. The method as claimed in claim 16, wherein the step of downloading the configuration files of different priority levels from the configuration server further comprises steps of:
determining whether the configuration file of the next priority level is detected in the configuration server if the downloading the configuration file of the next priority level is unsuccessful;
determining whether a priority level of the configuration file of the next priority level is the highest if the configuration file of the next priority level is not detected; and
if the priority level of the configuration file of the next priority level is not the highest, downloading a configuration file of the next priority level.

18. The method as claimed in claim 14, wherein the step of downloading the configuration files of different priority levels further comprises steps of:
determining whether the IP address of the backup configuration server is effective if the IP address of the configuration server is not effective; and
communicating with the backup configuration server, and downloading the configuration files of different priority levels from the backup configuration server if the IP address of the backup configuration server is effective.

19. The method as claimed in claim 18, wherein the step of downloading the configuration files of different priority levels from the backup configuration server comprises steps of:
downloading the configuration files of different priority levels;
determining whether the downloading is successful;
determining whether the configuration files are completely downloaded if the downloading is successful; and
if not completely downloaded, continuing downloading of the configuration files.

20. The method as claimed in claim 19, wherein the step of downloading the configuration files of different priority levels from the backup configuration server further comprises steps of:
determining whether an unsuccessful configuration file is detected in the backup configuration server if the downloading is not successful;
determining whether a priority level of the unsuccessful configuration file is the highest if the unsuccessful configuration file is not detected; and
if the priority level of the unsuccessful configuration file is not the highest, downloading the configuration file of the next priority level.
